(19) United States
(12) Patent Application Publication
(10) Pub. No.: US 2007/0195217 A1
(43) Pub. Date: Aug. 23, 2007

(54) Display device

(76) Inventors: Kiyoshi Miyashita, Nomi-shi (JP); Ikuo Matsunaga, Ishikawa-gun (JP); Masashi Ishimaru, Ishikawa-gun (JP); Yoshihito Nakawaga, Kanazawa-shi (JP); Masaki Seto, Kahoku-gun (JP); Jun Hanari, Kanazawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/653,266

(22) Filed: Jan. 16, 2007

(30) Foreign Application Priority Data
Jan. 16, 2006 (JP) 2006-007357

(51) Int. Cl. G02F 1/1333

(52) U.S. Cl. 349/54

(57) ABSTRACT

An intermediate portion of a low voltage power supply wire is extinguished by irradiation of a laser beam to form a wire cut portion. A different potential portion serves as the wire cut portion of the low voltage power supply wire. The distance between the end portions of a high voltage power supply wire and the low voltage power supply wire between which the potential is different is increased. An electrical short-circuit between the high voltage power supply wire and the low voltage power supply wire hardly occurs. Even when impurities invade into the gap between an insulating layer on the high voltage power supply wire and the low voltage power supply wire and a glass substrate, electrode corrosion of the high voltage power supply wire and the low voltage power supply wire can be prevented. A display failure can be prevented.

### INCORPORATION BY REFERENCE

The present invention claims priority under 35 U.S.C. §119 to Japanese Patent Application No. 2006-007357 filed on Jan. 16, 2006. The content of the application is incorporated herein by reference in its entirety.

### FIELD OF THE INVENTION

The present invention relates to a display device having a display region between a first substrate and a second substrate.

### BACKGROUND OF THE INVENTION

A flat panel display as this type of display device is very excellent in space saving, convenience and portability, and it is broadly used in a multimedia terminal as a liquid crystal display, organic EL (electroluminescence) display or the like.

An active type display driving technique has been mainly applied to the liquid crystal display and the organic EL display in order to implement excellent reproduction of pictures and information. The liquid crystal display is constructed by a liquid crystal display panel in which a counter substrate is disposed on an array substrate so that these substrates face each other.

Particularly, the array substrate of the liquid crystal display panel is very expensive, and rigorously checked after passing through a process of manufacturing the array substrate. The counter substrate is disposed so as to face the array substrate in a panel manufacturing process after the check, thereby forming a liquid crystal display panel. Here, as disclosed in Japanese Laid-Open Patent Publication No. 2002-229056, an image display region on which an image can be displayed is provided on the array substrate of the liquid crystal display panel, and a plurality of pixels are arranged in the image display region in a matrix form.

Furthermore, scan lines and signal lines necessary to actively drive the plurality of pixels are arranged in a grid form in the image display region. Power supply lines for supplying voltages to the scan lines and the signal lines are provided on the array substrate. These power supply lines are constructed by a plurality of power supply lines to which different voltages are applied, and provided over the region from a seal pattern portion provided at the outside of the image display region until the end portion of the array substrate. The power supply lines are electrically connected to check patterns for checking various defects in the manufacturing process of the array substrate. Therefore, these power supply lines are barely exposed on the end face of the array substrate.

Furthermore, the power supply lines are also barely exposed on the end face of the array substrate even in the completed liquid crystal display panel. Therefore, when current is supplied to the liquid crystal display panel under a high-humidity atmosphere, an electrical short-circuit may occur between power supply lines to which different voltages are applied, or the power supply lines may suffer metal corrosion, that is, electrical corrosion may occur. Accordingly, when the electrical short-circuit between the power supply lines to which the different voltages are applied or the metal corrosion reaches the seal pattern portion, the voltage applied to the plurality of pixels in the image display region may be varied. Accordingly, some display failure may occur in an image which is displayed in the image display region.

The present invention has been implemented in view of the foregoing point, and has an object to provide a display device that can prevent a display failure.

### SUMMARY OF THE INVENTION

The present invention is equipped with a first substrate and a second substrate disposed so as to face the first substrate, wherein a display region surrounding at least a partial region between the first substrate and the second substrate, and a first wire portion and a second wire portion are provided over a region from the display region to the edge portion of the first substrate so as to be adjacent to each other, and the first wire portion has a cut portion for electrically cutting the first wire portion in the vicinity of the edge portion of the first substrate.

According to the present invention, the cut portion for electrically cutting the first wire portion in the vicinity of the edge portion of the first substrate of the first wire portion is provided to the first wire portion out of the first wire portion and the second wire portion which are provided so as to be adjacent to each other over the region from the display region between the first substrate and the second substrate to the edge portion of the first substrate, whereby the cut portion serves as an end portion at which the potential of the first wire portion arises. Accordingly, the distance between the end portions at the display region side of the first wire portion and the second wire portion at which differential potentials occur can be increased. Therefore, the electrical short-circuit between the first wire portion and the second wire portion can be prevented, and the metal corrosion of the portion of the first wire portion at the display region side from the cut portion can be prevented, so that a display failure in the display region can be prevented.

### BRIEF DESCRIPTION OF THE DRAWINGS

FIG. 1 is a plan view showing a part of a first embodiment of a display device according to the present invention;

FIG. 2 is a cross-sectional view showing a part of the display device;

FIG. 3 is a cross-sectional view showing the display device;

FIG. 4 is a plan view showing the display device;

FIG. 5 is a plan view showing a part of a state of the display device before a first substrate is separated;

FIG. 6 is a plan view showing a part of a second embodiment of the display device according to the present invention;

FIG. 7 is a cross-sectional view showing a part of the display device;

FIG. 8 is a plan view showing a part of a third embodiment of the display device according to the present invention;

FIG. 9 is a cross-sectional view showing a part of the display device; and

FIG. 10 is a cross-sectional view showing a fourth embodiment of the display device according to the present invention.

### DETAILED DESCRIPTION OF THE PREFERRED EMBODIMENT

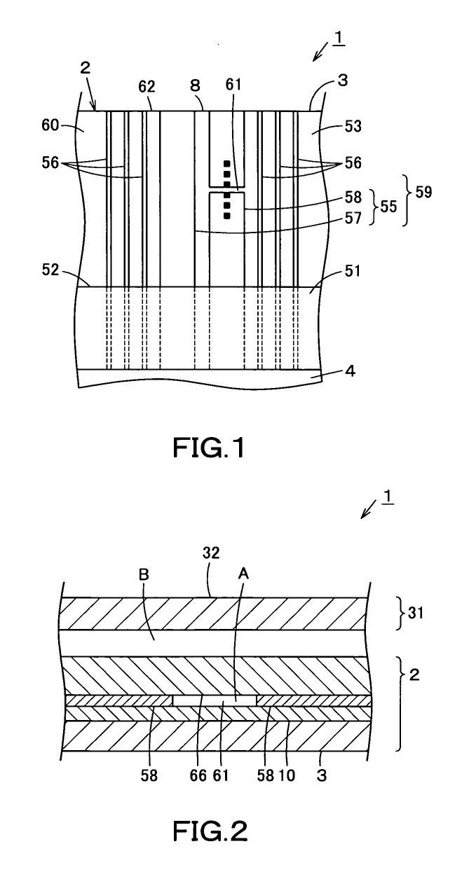

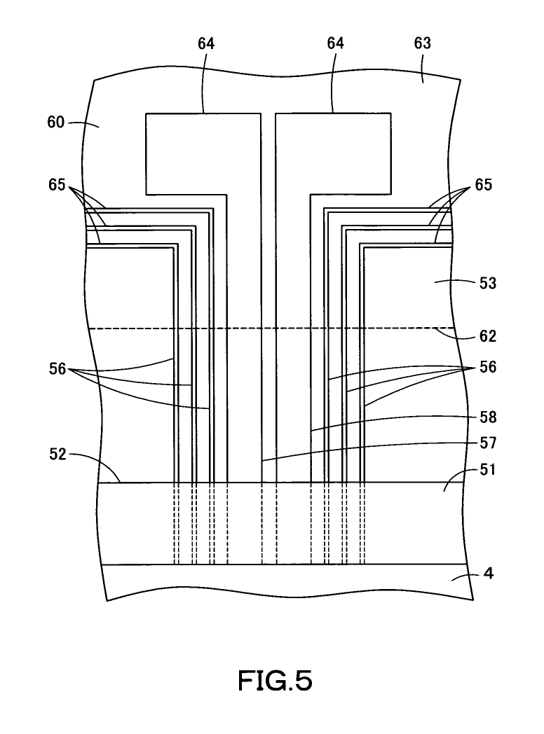

The construction of a first embodiment of a display device according to the present invention will be described with reference to FIG. 1 to FIG. 5.

In FIG. 1 to FIG. 5, reference numeral 1 represents a liquid crystal display panel as a display device. The liquid crystal display panel 1 is an active matrix type and reflection type liquid crystal display device. The liquid crystal display panel 1 has a substantially rectangular flat plate type array substrate 2 as a thin film transistor (TFT) substrate. The array substrate 2 has a glass substrate 3 as a substantially transparent rectangular flat plate type first substrate having both insulation property and translucent property. An image display region 4 which is rectangular in plan view and serves as a display region portion covering the center portion of the surface of the glass substrate 3 is provided at the center portion on the surface corresponding to one principal surface of the glass substrate 3. The image display region 4 is a region where an image can be displayed, and provided at the center portion in the width and longitudinal directions of the glass substrate 3.

In the image display region 4 are wired and provided a plurality of scan lines (not shown) which are arranged so as to be spaced from one another at equal intervals and parallel to one another along the lateral direction of the image display region 4, and also a plurality of signal lines (not shown) which are arranged so as to be spaced from one another at equal intervals and in parallel to one another along the longitudinal direction of the image display region 4. Each pixel 5 is provided in each of regions which are sectioned and surrounded by these scan lines and the signal lines. Accordingly, these pixels 5 are provided in a matrix form along the longitudinal and lateral directions of the image display region 4 within the image display region 4.

Furthermore, as one pixel constituent element, each of these pixels 5 is provided with a thin film transistor (TFT) 6 as a TFT element serving as a switching element, a pixel electrode 7 formed of reflection metal such as aluminum (Al) or the like, and an auxiliary capacitor (not shown) serving as a storage capacitor. Here, each thin film transistor 6 is provided at the cross portion between a scan line and a signal line. Each pixel electrode 7 is electrically connected to the thin film transistor 6 in the same pixel 5, and a voltage can be selectively applied by the thin film transistor 6.

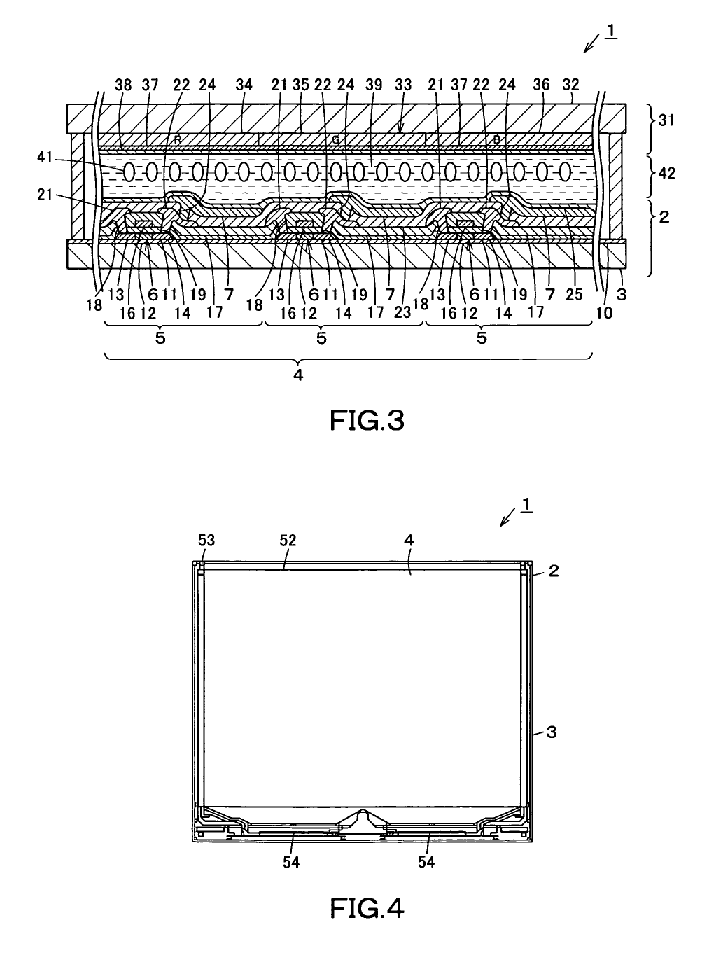

As shown in FIG. 3, an undercoat layer 10 as an insulating layer having insulating property is formed on the whole of the glass substrate 3 of the array substrate 2 to prevent diffusion of impurities from the glass substrate 3. An island-shaped active layer 11 as a semiconductor layer is provided on the undercoat layer 10. Here, the active layer 11 is formed of polysilicon (p-Si) as a polycrystalline semiconductor which is achieved by irradiating an excimer laser beam to amorphous silicon (a-Si) as amorphous semiconductor so that the amorphous silicon (a-Si) is subjected to laser annealing and thus crystallized.

A channel region 12 is provided at the center portion in the lateral direction of the active layer 11, and a source region 13 and a drain region 14 are provided at both sides between the channel region 12 is sandwiched. Furthermore, a gate insulating film 15 is formed on the undercoat layer 10 so as to cover the active layer 11, and a gate electrode 16 is laminated on the gate insulating film 15 facing the channel region 12 of the active layer 11. The thin film transistor 6 is constructed by the gate electrode 16, the gate insulating film 15 and the active layer 11.

Furthermore, an interlayer insulating film 17 is laminated on the gate insulating film 15 of the thin film transistor 6 so as to cover the gate electrode 16 of the thin film transistor 6. Furthermore, first contact holes 18 and 19 are provided in the interlayer insulating film 17 and the gate insulating film 15 so as to penetrate through the interlayer insulating film 17 and the gate insulating film 15 and communicate with the source region 13 and the drain region 14 of the active layer 11. A source electrode 21 is laminated on the first contact hole 18 penetrating to the source region 13 of the active layer 11 and the interlayer insulating film 17, and the source electrode 21 is electrically connected to the source region 13 of the active layer 11. Furthermore, a drain electrode 22 is laminated on the first contact hole 19 penetrating to the drain region 14 of the active layer 11 and the interlayer insulating film 17, and the drain electrode 22 is electrically connected to the drain region 14 of the active layer 11.

Furthermore, a passivation film 23 as a protection film is laminated on the interlayer insulating film 17 so as to cover the source electrode 21 and the drain electrode 22. The passivation film 23 is provided with a second contact hole 24 which penetrates through the passivation film 23 and communicates with the drain electrode 22. The pixel electrode 7 is laminated on the second contact hole 24 and the passivation film 23, and the pixel electrode 7 is electrically connected to the drain electrode 22 via the second contact hole 24. Furthermore, an orientation film 25 of polyimide which is subjected to an orientation treatment is laminated on the passivation film 23 so as to cover the pixel electrode 7.

Furthermore, a counter substrate 31 as a common electrode substrate is disposed so as to face the orientation film 25. The counter substrate 31 is equipped with a glass substrate 32 as an insulating substrate serving as a substantially transparent second substrate having translucency. A color filter layer 33 as a colored layer is laminated on the whole surface of the glass substrate 32 which faces the orientation film 25. In the color filter layer 33, a red layer 34 as a first colored layer, a green layer 35 as a second colored layer and a blue layer 36 as a third colored layer which correspond to three primary colors of light are repetitively arranged in conformity with the pixel electrode 7 of each pixel 5.

A counter electrode 37 as a common electrode is laminated on the whole surface of the color filter layer 33. Furthermore, an orientation film 38 of polyimide which is subjected to an orientation treatment is laminated on the counter electrode 37. The gap between the orientation film 38 and the orientation film 25 of the array substrate 2 serves as a liquid crystal sealing region 39, and liquid crystal composition 41 is injected and sealed in the liquid crystal sealing region 39 to provide a liquid crystal layer 42 as an optical modulation layer. Furthermore, a polarizing plate (not shown) is provided at the surface side of the glass substrate 32.

As shown in FIG. 1, a rectangular frame-shaped seal region 51 as a seal pattern portion covering the outer periphery of the image display region 4 is provided at the outside of the image display region 4 on the glass substrate 3 of the array substrate 2. The seal region 51 is provided so as to be continuous with the outside of the image display region 4. The seal region 51 is coated with seal agent 52 for adhesively joining the counter substrate 31 to the surface of the array substrate 2 and sealing the liquid crystal sealing region 39 between the array substrate 2 and the counter substrate 31.

Furthermore, a rectangular frame-shaped wire region 53 as a display region peripheral portion for covering the seal region 51 is provided at the outside of the seal region 51 on the surface of the glass substrate 3. The wire region 53 is provided so as to be continuous with the outside of the seal region 51 and cover the outer periphery of the seal region 51. The wire region 53 is located at the outside of the seal region 51 on the surface of the glass substrate 3 and extends from the outer edge of the seal region 51 to the outer edge of the glass substrate 3.

Here, a driving wire portion 54 which is electrically connected to the scan lines and the signal lines wired in the image display region 4 on the glass substrate 3 is provided in the wire region 53 located at the lower edge as one side edge in the lateral direction of the glass substrate 3. Check power source supply lines 55 as a plurality of power supply lines for supplying voltages to the scan lines and the signal lines in the image display region 4 and dummy metal wires 56 are provided to the portion located at the upper edge as the other side edge in the lateral direction of the glass substrate 3 and the portions located at both edges in the longitudinal direction of the glass substrate in the wire region 53.

These check power source supply lines 55 and the dummy metal wires 56 are provided on the undercoat layer 10 laminated on the glass substrate 3, and they are linearly provided over the region from the upper edge of the image display region 4 via the seal region 51 to the end surface 8 of the glass substrate 3 as the outer edge of the wire region 53. Furthermore, the check power source supply lines 55 and the dummy metal wires 56 are linearly wired along the direction which vertically crosses the upper edge of the glass substrate 3.

Specifically, the check power source supply lines 55 are supplied with signals from an array tester (not shown) which is set as a test device at the outside, and supplies signals to the scan lines and the signal lines wired in the image display region 4 on the glass substrate 3 of the array substrate 2 to check the driving of each pixel 5 provided in the image display region 4. Furthermore, these check power source supply lines 55, as shown in FIG. 1, have a plurality of power supply line groups 59 including a high voltage power supply wire 57 as a first wire portion at a high voltage side to which a high voltage of +10V, more preferably +5.5V is applied, and a low voltage power supply wire 58 as a second wire portion at a low voltage side to which a low voltage different from the voltage applied to the high voltage power supply wire 57 and lower than the voltage concerned, for example, a voltage of −9V, more preferably 0V is applied.

At least one pair of the high voltage power supply wire 57 and the low voltage power supply wire 58 are provided at these power source line groups 59. The high voltage power supply wire 57 and the low voltage power supply wire 58 of the power source line groups 59 are provided like belts having the same lateral direction, and juxtaposed in parallel with one another so as to be spaced from each other via a fixed interval. Specifically, the high voltage power supply wire 57 and the low voltage power supply wire 58 are wired so as to be adjacent to each other through a gap of about a half of the width dimension of each of the high voltage power supply wire 57 and the low voltage power supply wire 58, for example, 30μm±5μm.

Here, a wire cut portion 61 as a cut portion which is released by electrically cutting the low voltage power supply wire 58 along the lateral direction is provided at the center portion in the longitudinal direction of a portion of the low voltage power supply wire 58 which is laminated on the wire region 53. The wire cut portion 61 is located in the vicinity of the edge portion in the lateral direction of the wire region 53, and provided between the outer edge of the seal region 51 and the edge portion of the glass substrate 3. The wire cut portion 61 is provided to irradiate a predetermined laser beam along the lateral direction of the low voltage power supply wire 58. That is, the wire cut portion 61 is achieved by oxidizing or extinguishing the low voltage power supply wire 58 over the whole region thereof in the lateral direction so that the low voltage power supply wire 58 is physically cut and thus made electrically high in resistance or cut.

Furthermore, the high voltage power supply wire 57 and the low voltage power supply wire 58 are linearly arranged from the inside of the image display region 4 to a scribe line 62 as a fracture line corresponding to the outer edge of the wire region 53. Here, the scribe line 62 is a dividing line provided to a mother substrate 63 as a large-size glass substrate before the glass substrate 3 is divided. The mother substrate 63 is divided along the scribe line 62, thereby manufacturing the glass substrate 3 from the mother substrate 63.

Here, the high voltage power supply wire 57, the low voltage power supply wire 58 and the dummy metal wires 56 are wired so as to extend from the wire region 53 of the glass substrate 3 to the upper side of the peripheral region 60 of the mother substrate 63 beyond the scribe line 62 as shown in FIG. 5. Power supply patterns 64 as defect checking patterns which are integrally and electrically connected to the tip portions of the high voltage power supply wire 57 and the low voltage power supply wire 58 are provided on the peripheral region 60 of the mother substrate 63 beyond the scribe line 62. These power supply patterns 64 are check patterns for checking lighting used for tests by the array tester, and it is cut and removed along the scribe line 62 after the lighting is checked by the array tester. Specifically, these power supply patterns 64 are formed in a rectangular shape in plan view, and the facing inner surfaces of the power supply patterns 64 are provided along the opposing inner edges of the high voltage power supply wire 57 and the low voltage power supply wire 58. Accordingly, these power supply patterns 64 are formed so as to project to the opposite sides.

Furthermore, linear dummy patterns 65 which are integrally and electrically connected to the tip portions of the dummy metal wires 56 are provided on the peripheral region 60 of the mother substrate 63 beyond the scribe line 62. These dummy patterns 65 are designed so that the tip portions thereof are vertically bent to the opposite sides along the outer edge of the power supply patterns 64. Accordingly, the mother substrate 63 is cut along the scribe line 62 to remove the peripheral region 60, whereby the tip portions of the high voltage power supply wire 57, the low voltage power supply wire 58 and the dummy metal wires 56 laminated on the wire region 53 are electrically exposed at the outer edge of the glass substrate 3.

Furthermore, a plurality of dummy metal wires 56 are wired in parallel along the longitudinal direction of the high voltage power supply wire 57 and the low voltage power supply wire 58. For example, three dummy metal wires 56 are provided at the opposite side of the high voltage power supply wire 57 to the side at which the low voltage power supply wire 58 is located, and also three dummy metal wires 56 are provided at the opposite side of the low voltage power supply wire 58 to the side at which the high voltage power supply wire 57 is located. Furthermore, the dummy metal wires 56 are wired so as to be spaced from one another via the gap of about a half of the width dimension of each of the high voltage power supply wire 57 and the low voltage power supply wire 58, and linearly arranged so as to extend from the inside of the image display region 4 to the scribe line 62.

Here, an insulating layer 66 formed of the same material as the interlayer insulating film 17 in the same process as the interlayer insulating film 17 on the surface of the wire region 53 on which the high voltage power supply wire 57, the low voltage power supply wire 58 and the dummy metal wires 56 are laminated. The insulating layer 66 is formed of silicon nitride (SiN), for example. The insulating layer 66 is laminated on the undercoat layer 10 laminated in the wire region 53, and covers the high voltage power supply wire 57, the low voltage power supply wire 58 and the dummy metal wires 56 laminated on the undercoat layer 10. Furthermore, a predetermined gap A is provided between the insulating layer 66 and the undercoat layer 10 in the wire cut portion 61 of the low voltage power supply wire 58. The counter substrate 31 is secured so as to face the surface of the insulating layer 66, and a predetermined gap B is provided between the counter substrate 31 and the insulating layer 66.

Furthermore, at the portions of the high voltage power supply wire 57, the low voltage power supply wire 58 and the dummy metal wire 56 which are laminated on the seal region 51, seal agent 52 is coated and laminated on the high voltage power supply wire 57, the low voltage power supply wire 58 and the dummy metal wire 56. Accordingly, the seal agent 52 covers each of the high voltage power supply wire 57, the low voltage power supply wire 58 and the dummy metal wire 56 over the lateral direction in each seal region 51.

Next, the operation of the liquid crystal display panel according to the first embodiment will be described.

First, as shown in FIG. 5, check terminals (not shown) of the array tester are electrically connected and conducted to the high voltage power supply wire 57 and the low voltage power supply wire 58 of the respective power supply group 59 of the check power source supply lines 55 laminated on the peripheral region 60 of the mother substrate 63 before the mother substrate 63 is divided along the scribe line 62 and thus the glass substrate 3 is achieved.

Under this state, check signals are input from the check terminals of the array tester to the high voltage power supply wire 57 and the low voltage power supply wire 58 of the respective power supply line groups 59, and supplied to the scan lines and the signal lines wired in the image display region 4 on the mother substrate 63, thereby driving the respective pixels 5 of the image display region 4.

On the basis of the driving of the respective pixel 5 of the image display region 4 based on the check signals, it is checked through lighting whether the respective pixels 5 normally operate.

After the lighting check of each pixel 5 of the image display region 4 by the array tester is completed, the mother substrate 63 provided with the image display region 4 is cut along the scribe line 62 as shown in FIG. 1, and the peripheral region 60 is removed from the mother substrate 63 to achieve the glass substrate 3.

At this time, the dummy metal wires 56, the high voltage power supply wire 57 and the low voltage power supply wire 58 are cut and removed from the power supply pattern 64 and the dummy pattern 65 along the scribe line 62 at the dividing time of the scribe line 62, whereby the tip portions of the dummy metal wire 56, the high voltage power supply wire 57 and the low voltage power wire 58 are electrically exposed at the outer edge of the glass substrate 3.

Therefore, when the liquid crystal display panel 1 manufactured so that the counter substrate 31 faces the glass substrate 3 is supplied with current under a humid atmosphere in which the humidity is high, the voltages are applied via the signal lines or the scan lines to the high voltage power supply wire 57 and the low voltage power supply wire 58 wired on the glass substrate 3, so that the potential is different between the high voltage wire 57 and the low voltage power supply wire 58. Accordingly, leak current may flow along the creepage surface between the high voltage power supply wire 57 and the low voltage power supply wire 58, so that an electrical short-circuit, leak or the like occurs. Furthermore, impurities may invade from the outside into the gap B between the high voltage power supply wire 57 and the low voltage power supply wire 58, so that electrode corrosion (electric corrosion) caused by metal corrosion occurs.

When the electric corrosion or the electrical short-circuit reaches the seal agent 52 of the seal region 51, the liquid crystal composition 41 filled in the liquid crystal sealing region 39 inside the seal agent 52 may be polluted, and also the pixels 5 of the image display region 4 provided inside the seal agent 52 may be corroded. This causes the display failure of the liquid crystal display panel 1, and the reliability of the liquid crystal display panel 1 maybe lowered.

Therefore, as in the case of the first embodiment, a predetermined laser beam is irradiated from the surface side of the glass substrate 3 along the lateral direction of the low voltage power supply wire 58 to the center portion in the longitudinal direction of the portion laminated on the wire region 53 of the low voltage power supply wire 58 which more easily suffers metal corrosion than the high voltage power supply wire 57 out of the power supply line groups 59 laminated on the glass substrate 3. With the laser beam, the center portion in the longitudinal direction of the portion of the low voltage power supply wire 58 which is laminated on the wire region 53 is burned out to be extinguished over the whole portion in the lateral direction of the low voltage power supply wire 58, thereby forming the wire cut portion 61.

At this time, the wire cut portion 61 is provided to only the low voltage power supply wire 58 by irradiating the laser beam, and a part of the low voltage power supply wire 58 is scattered to the surrounding of the portion at which the wire cut portion 61 is provided.

As a result, by providing the wire cut portion 61 to the low voltage power supply wire 58, the extension of the low potential portion of the low voltage power supply wire 58 is stopped at the wire cut portion 61 of the low voltage power supply wire 58. On the other hand, the high potential portion of the high voltage power supply wire 57 wired so as to be adjacent to the low voltage power supply wire 58 extends to the end face at the tip side of the high voltage power supply wire 57.

Accordingly, the distance between the end portions of the high voltage power supply wire 57 and the low voltage power supply wire 58 at which the potentials are different from each other is increased. Accordingly, even when the liquid crystal display panel 1 is supplied with current and thus operated under the high-humidity atmosphere, an electrical short-circuit or leak hardly occurs between the high voltage power supply wire 57 and the low voltage power supply wire 58.

Furthermore, even when impurities invade into the gap B between the insulating layer 66 laminated on the adjacent high voltage power supply wire 57 and low voltage power supply wire 58 of the liquid crystal display panel 1 and the glass substrate 32 of the counter substrate 31, occurrence of the electrode corrosion and wire corrosion of the high voltage power supply wire 57 and the low voltage power supply wire 58 can be improved and prevented. Accordingly, the display degradation of the liquid crystal display panel 1 can be prevented, and the reliability and corrosion problem of the liquid crystal display panel 1 can be improved, and thus there can be provided the liquid crystal display panel 1 having a display quality with high reliability and a long lifetime.

Furthermore, a laser beam is irradiated to the portion laminated on the wire region 53 of the low voltage power supply wire 58 which more easily suffers metal corrosion than the high voltage power supply wire 57, thereby forming the wire cut portion 61, whereby the metal corrosion of the high voltage power supply wire 57 and the low voltage power supply wire 58 can efficiently be prevented as compared with the case where the wire cut portion 61 is provided to the high voltage power supply wire 57.

Here, the wire cut portion 61 may be provided to each of the high voltage power supply wire 57 and the low voltage power supply wire 58. In this case, when these wire cut portions 61 are linearly and continuously formed by the same laser beam, the distance between the end portions of the high voltage power supply wire 57 and the low voltage power supply wire 58 between which the potential is different is short, and thus the electrode corrosion is easily shifted. Therefore, it is necessary that the wire cut portions 61 are provided at displaced positions along the longitudinal direction of the high voltage power supply wire 57 and the low voltage power supply wire 58, thereby increasing the distance between the end portions of the high voltage power supply wire 57 and the low voltage power supply wire 58 between which the potential is different.

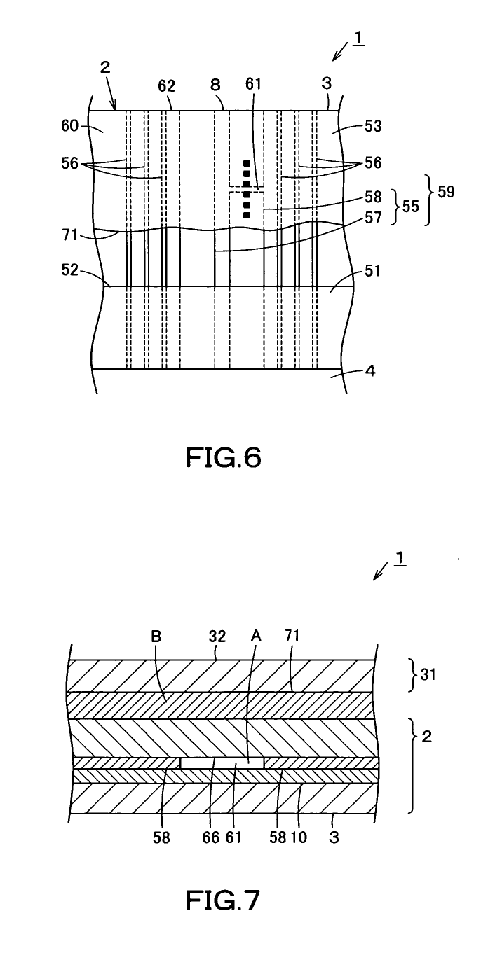

In the first embodiment, the gap B is formed between the glass substrate 32 of the counter substrate 31 of the wire region 53 of the liquid crystal display panel 1 and the insulating layer 66 of the array substrate 2. However, as in the case of a second embodiment shown in FIG. 6 and FIG. 7, insulating resin having a waterproof property is filled into the gap B between the insulating layer 66 of the wire region 53 and the glass substrate 32 by the capillary phenomenon to form a waterproof resin layer 71 formed at a protection layer in the gap B, so that the gap B is coated.

The waterproof resin layer 71 is formed of synthetic resin having an insulating property, and it is filled from the scribe line 62 side as the outer edge of the wire region 53 on the glass substrate 3 of the array substrate 2, so that it occupies a region of substantially two thirds of the wire region 53. The waterproof resin layer 71 is filled over the region extending from the outer edge of the seal region 51 on the glass substrate 3 via a predetermined gap. Furthermore, the waterproof resin layer 71 is filled and formed in the gap B between the insulating layer 66 on the wire region 53 of the array substrate 2 and the glass substrate 32 of the counter substrate 31.

That is, the waterproof resin layer 71 is coated on the tip portion of each dummy metal wire 56, the tip portion corresponding to the end face of the high potential portion of the high voltage power supply wire 57 and the wire cut portion 61 serving as the low potential end portion of the low voltage power supply wire 58 which are provided in the wire region 53 on the glass substrate 3 of the array substrate 2. After the mother substrate 63 is cut along the scribe line 62 and the peripheral region 60 is removed to achieve the glass substrate 3, the waterproof resin layer 71 is filled and formed from the end face side corresponding to the outer edge of the glass substrate 3. Accordingly, the waterproof resin layer 71 covers the end faces of the high voltage power supply wire 57 and low voltage power supply wire 58 which are exposed at the end face portion of the glass substrate 3.

As a result, by irradiating a laser beam to a part of the low voltage power supply wire 58 to extinguish the part concerned, thereby forming the wire cut portion 61, the low voltage power supply wire 58 is electrically cut at the wire cut portion 61, so that the operation and effect of the first embodiment can be achieved. Furthermore, the insulating resin having a waterproof property is filled from the outer edge of the wire region 53 into the gap B between the insulating layer 66 and the glass substrate 32 of the counter substrate 31 to form the waterproof resin layer 71, whereby the end faces of the high voltage power supply wire 57 and the low voltage power supply wire 58 which is exposed at the end face portion of the glass substrate 3 are covered by the waterproof resin layer 71. Therefore, the end faces of the high voltage power supply wire 57 and the low voltage power supply wire 58 can be covered.

Accordingly, impurities can be prevented from invading from the outside into the gap B between the insulating layer 66 and the glass substrate 32 of the counter substrate 31, and thus the electrode corrosion of the high voltage power supply wire 57 and the low voltage power supply wire 58 due to invasion of impurities into the gap B can be prevented. Accordingly, the display failure of the liquid crystal display panel 1 can reliably be prevented, and thus there can be provided the liquid crystal display panel 1 having a display quality with high reliability and a long lifetime.

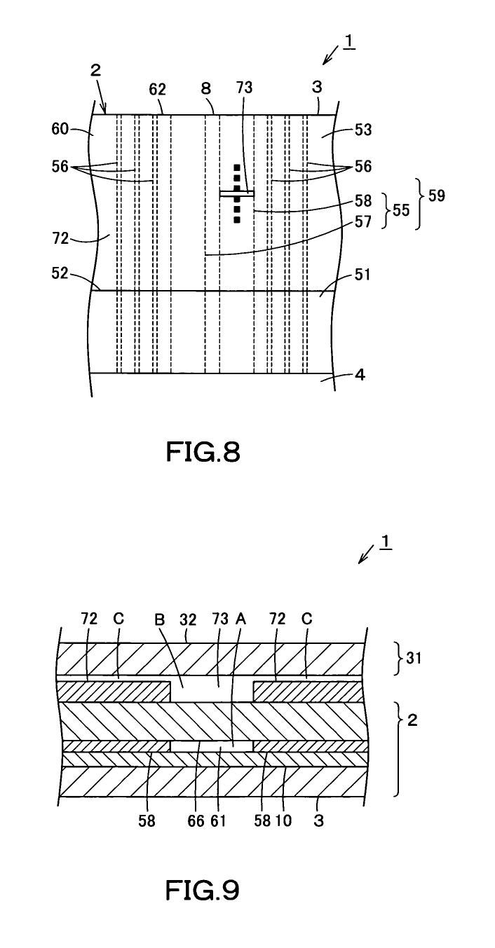

Furthermore, as in the case of a third embodiment shown in FIG. 8 and FIG. 9, polymer resin is patterned on the insulating layer 66 laminated on the wire region 53 of the mother substrate 63 to laminate a polymer resin layer 72 as a protection layer, whereby the dummy metal wires 56, the high voltage power supply wire 57 and the low voltage power supply wire 58 which are wired in the wire region 53 are covered by the polymer resin layer 72. That is, the polymer resin layer 72 is provided over the region extending from the outer edge of the seal region 51 of the glass substrate 3 of the array substrate 2 to the end face of the glass substrate 3 which corresponds to the outer edge of the wire region 53.

The polymer resin layer 72 is formed of organic film which is not damaged and melted by irradiation of the laser beam to be irradiated when the wire cut portion 61 is formed in the low voltage power supply wire 58, and through which no laser beam is transmitted. Furthermore, the polymer resin layer 72 is formed in advance in the process of manufacturing the array substrate 2 before the mother substrate 63 is cut along the scribe line 62 and also before the counter substrate 31 is opposed to and secured onto the array substrate 2. Furthermore, the polymer resin layer 72 is formed except for the region in which the wire cut portion 61 of the low voltage power supply wire 58 provided to the wire region 53 is formed. Still furthermore, the polymer resin layer 72 is located in the gap B between the insulating layer 66 of the array substrate 2 and the glass substrate 32 of the counter substrate 31, and has a thickness dimension slightly smaller than the gap dimension of the gap B.

Furthermore, the polymer resin layer 72 is opened in a slender rectangular shape at a portion thereof which faces the region where the wire cut portion 61 of the low voltage power supply wire 58 is formed, so that an opening portion 73 serving as a laser transmission opening is formed. This opening portion 73 is formed in a slender rectangular shape in a plan view so as to face the center portion in the longitudinal direction of the portion laminated on the wire region 53 of the low voltage power supply wire 58 and so as to face the overall portion along the lateral direction of the low voltage power supply wire 58. That is, the opening portion 73 is located in the vicinity of the edge portion in the lateral direction of the wire region 53, and provided between the outer edge of the seal region 51 and the edge portion of the glass substrate 3. A laser beam is irradiated from the surface side of the glass substrate 3 via the opening portion 73 to the low voltage power supply wire 58, whereby the wire cut portion 61 is formed so as to face the opening portion 73 of the low voltage power supply wire 58.

As a result, a laser beam is irradiated to a part of the low voltage power supply wire 58 via the opening portion 73 of the polymer resin layer 72 to extinguish the part concerned, thereby forming the wire cut portion 61. Therefore, the low voltage power supply wire 58 is electrically cut at the wire cut portion 61, and thus the same operation and effect as the first embodiment can be achieved. Furthermore, the polymer resin 72 is laminated on the insulating layer 66 of the wire region 53 of the array substrate 2, whereby the gap B between the insulating layer 66 and the glass substrate 32 of the counter substrate 31 is covered by the polymer resin 72, and thus the invasion of impurities from the outside into the gap B can be prevented as much as possible. Accordingly, the electrode corrosion of each of the high voltage power supply wire 57 and the low voltage power supply wire 58 due to invasion of impurities into the gap B can be prevented, and thus there can be provided the liquid crystal display panel 1 having a display quality with high reliability.

In the third embodiment described above, the polymer resin layer 72 is laminated on the insulating layer 66 of the wire region 53 of the glass substrate 3 of the array substrate 2, and the gap B between the insulating layer 66 and the glass substrate 32 of the counter substrate 31 is covered by the polymer resin layer 72. However, when a gap C is formed between the polymer resin layer 72 and the glass substrate 32 of the counter substrate 31, insulating resin having a waterproof property may be filled into the gap C by infiltration using the capillary phenomenon, whereby a waterproof resin layer 71 is formed in the gap C between the polymer resin layer 72 and the glass substrate 32 of the counter substrate 31.

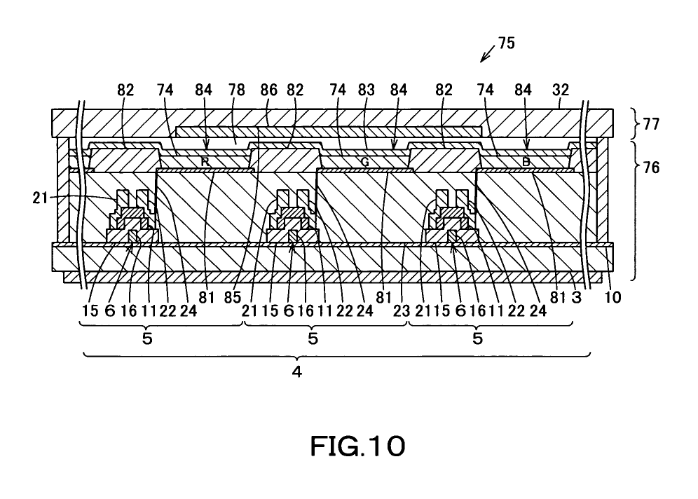

Furthermore, in each of the above-described embodiments, the liquid crystal display panel 1 uses the liquid crystal layer 42 as the optical modulation layer, however, an organic EL display panel 75 may be used as a display device using an organic EL (electroluminescence) layer 74 as a light emitting layer as in the case of a fourth embodiment shown in FIG. 10. The organic EL display panel 75 is equipped with an active matrix substrate 76 as a TFT substrate, and a sealing substrate 77 as cap glass. The active matrix substrate 76 and the sealing substrate 77 are disposed so as to face each other via a predetermined gap, and the outer peripheral edges thereof are adhesively attached to each other by seal agent 52. Furthermore, the space portion 78 between the active matrix substrate 76 and the sealing substrate 77 which is hermetically sealed by the seal agent 52 is filled with inert gas such as argon (Ar) gas, nitrogen (N₂) gas or the like.

The active matrix substrate 76 is equipped with the glass substrate 3, and the image display region 4 is provided on the surface as one principal surface of the glass substrate 3. Scan signal lines and picture signal lines (not shown) are wired in a grid form in the image display region 4. A pixel 5 is provided within a region partitioned by the scan signal lines and the picture signal lines. These pixels 5 are equipped with a thin film transistor 6 as a driving transistor laminated on the under coat layer 10 on the glass substrate 3. Furthermore, a passivation film 23 is laminated on the undercoat layer 10 so as to cover the thin film transistor 6, and a second contact hole 24 is provided in the passivation film 23. A first electrode 81 as an ITO anode is laminated on the second contact hole 24 and the passivation film 23.

Furthermore, the organic EL layer 74 as an organic layer as a light emitting layer is laminated on the first electrode 81 of each pixel 5. The organic EL layers 74 are constructed by luminescence organic compounds of red, green and blue corresponding to three primary colors of light, for example, and the luminescent organic compounds of red, green and blue are alternately laminated along the longitudinal direction and the lateral direction of the image display region 4. A rib layer 82 formed of acrylic resin or the like is laminated between the organic EL layers 74 of the respective pixels 5. The rib layer 82 is laminated between the organic EL layers 74 on the passivation film 23, and it is formed to be larger in thickness than the organic EL layer 74.

Furthermore, a second electrode 83 corresponding to a common electrode as an aluminum cathode is laminated on the whole surface of each of the organic EL layer 74 and the rib layer 82. As a result, an organic EL element 84 is constructed by the second electrode 83, the organic EL layer 74 and the first electrode 81. The sealing substrate 77 is secured so as to face the second electrode 83 of the organic EL element 84. The sealing substrate 77 has the glass substrate 32, and the portion facing the image display region 4 on the surface corresponding to one principal face of the glass substrate 32 is provided with a plurality of accommodating recess portions 85 each of which has a concaved cross section. Sheet-shaped drying agent 86 is accommodated in each of these accommodating recess portions 85. The drying agent 86 is formed of calcium oxide (CaO) or the like, and it is secured to dry the atmosphere in the space portion 78 between the glass substrate 32 of the sealing substrate 77 and the second electrode 83 of the active matrix substrate 76 and prevent degradation of the organic EL layers 74 due to moisture.

On the other hand, the wire region 53 is provided on the outer periphery of the seal region 51 which is coated with the seal agent 52 in the glass substrate 3 of the active matrix substrate 76, and the check power source supply lines 55 and the dummy metal wires 56 which are electrically connected to any one of the scan signal lines and the picture signal lines on the glass substrate are wired in the wire region 53. Furthermore, the wire cut portion 61 is provided to the low voltage power supply wire 58 of the power supply line group 59 of the check power source supply line 55. Accordingly, by providing the wire cut portion 61 to the low voltage power supply wire 58, the low voltage power supply wire 58 is electrically cut at the wire cut portion 61, and thus the same operation and effect as the first embodiment can be achieved by even the organic EL display panel 75.

In each of the above-described embodiments, a laser beam is irradiated to the low voltage power supply wire 58 to linearly extinguish the low voltage power supply wire 58 in the lateral direction, thereby forming the wire cut portion 61. However, a part of the low voltage power supply wire 58 may be electrically cut by increasing the resistance value of a part of the low voltage power supply wire 58 to make the resistance thereof higher or the like.

Furthermore, the liquid crystal display panel 1 and the organic EL display panel 75 in which the thin film transistor 6 having the active layer 11 formed of polysilicon is used as a switching element have been described. However, another switching element such as a thin film diode (TFD) or the like may be adaptively and used. Still furthermore, other display devices such as a plasmas display panel, etc., other than the liquid crystal display panel 1 and the organic EL display panel 75 may be adaptively used.

What is claimed is:

1. A display device comprising:
a first substrate; and
a second substrate disposed so as to face the first substrate, wherein a display region surrounding at least a partial region between the first substrate and the second substrate, and a first wire portion and a second wire portion are provided over a region from the display region to the edge portion of the first substrate so as to be adjacent to each other, and the first wire portion has a cut portion for electrically cutting the first wire portion in the vicinity of the edge portion of the first substrate.

2. The display device according to claim 1, wherein a seal region that covers at least a part of the outside of the display region and seals the first substrate and the second substrate is provided between the first substrate and the second substrate, and the cut portion is provided between the seal region and the edge portion of the first substrate.

3. The display device according to claim 1, wherein a voltage lower than a voltage applied to the second wire portion is applied to the first wire portion.

4. The display device according to claim 1, wherein the first wire portion and the second wire portion are power supply lines.

5. The display device according to claim 1, wherein the cut portion is provided by oxidizing the first wire portion to electrically make the first wire portion high in resistance.

6. The display device according to claim 1, wherein the cut portion is provided by burning out and physically cutting the first portion.

7. The display device according to claim 2, wherein a protection layer is provided in an outside region of the seal region between the first substrate and the second substrate.

8. The display device according to claim 2, wherein a wire region continuous with the outside of the seal region is provided between the first substrate and the second substrate, and the cut portion is provided in the wire region.

9. The display device according to claim 8, wherein the first wire portion and the second wire portion are provided so as to extend from the edge portion of the display region via the seal region to the outer edge of the wire region.

10. A liquid crystal display device comprising:
a first substrate;
a second substrate disposed so as to face the first substrate; and
a liquid crystal layer interposed between the first substrate and the second substrate, wherein a display region surrounding at least a partial region of the portion at which the liquid crystal layer is interposed between the first substrate and the second substrate, a first wire portion and a second wire portion provided so as to be adjacent to each other in a region extending from the display region to the edge portion of the first substrate are provided between the first substrate and the second substrate, and
the first wire portion is equipped with a cut portion achieved by electrically cutting the first wire portion in the vicinity of the edge portion of the first substrate.

11. A light emitting display device comprising;
a first substrate;
a light emitting layer provided on the first substrate; and
a second substrate provided at a side of the first substrate that faces the light emitting layer, wherein
a display region surrounding at least a partial region of the portion at which the light emitting layer is interposed between the first substrate and the second substrate, a first wire portion and a second wire portion provided so as to be adjacent to each other in a region extending from the display region to the edge portion of the first substrate are provided between the first substrate and the second substrate, and
the first wire portion is equipped with a cut portion achieved by electrically cutting the first wire portion in the vicinity of the edge portion of the first substrate.
